(19) United States
(12) Patent Application Publication
(10) Pub. No.: US 2003/0228821 A1
(43) Pub. Date: Dec. 11, 2003

(54) Fire-retardant fabric with improved tear, cut, and abrasion resistance

(76) Inventors: Reiyao Zhu, Midlothian, VA (US); Richard H. Young, Richmond, VA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/164,049

(22) Filed: Jun. 6, 2002

(51) Int. Cl. B32B 5/08; B32B 17/02; D03D 15/00

(52) U.S. Cl. 442/197; 442/217; 442/220; 442/219; 442/301; 442/198

(57) ABSTRACT

A woven fabric useful in protective apparel made from yarn components comprising a body fabric yarn component and a cut resistant ripstop yarn component having at least 50% greater tensile strength than the body fabric yarn component and comprising a yarn having a synthetic staple-fiber sheath and inorganic core, the body fabric yarn component and the cut resistant ripstop yarn component both being comprised of at least one yarn and each yarn component distinguished from the adjacent yarn component by interweaving orthogonal yarn components.

### BACKGROUND OF THE INVENTION

This invention relates to fabrics useful in protective garments, especially garments known as turnout gear which are useful for firefighters, but such fabrics and garments also have use in industrial applications where workers may be exposed to abrasive and mechanically harsh environments where fire and flame protection is needed. The garments, which include coats, coveralls, jackets, and/or pants can provide protection against fire, flame, and heat.

Most turnout gear commonly used by firefighters in the United States comprise three layers, each performing a distinct function. There is an outer shell fabric often made from flame resistant aramid fiber such as poly (meta-phenylene iosphthalamide) (MPD-I) or poly (para-phenylene terephthalamide) (PPD-T) or blends of those fibers with flame resistant fibers such as polybenzimidazoles (PBI). Adjacent to the outer shell fabric is a moisture barrier and common moisture barriers include a laminate of Crosstech® PTFE membrane on a woven MPD-I/PPD-T substrate, or a laminate of neoprene on a fibrous woven polyester/cotton substrate. Adjacent the moisture barrier is an insulating thermal liner which generally comprises a batt of heat resistant fiber.

The outer shell serves as initial flame protection while the thermal liner and moisture barrier protect against heat stress.

Since the outer shell provides primary defense it is desirable that this shell be durable and able to withstand abrasion and not tear or be cut in harsh environments. This invention provides for such a fabric that is flame resistant and has improved tear, cut, and abrasion attributes.

There are a number of fabrics described in the prior art which utilize bare steel wires and cords, primarily as armored fabrics. For example, WO 9727769 (Bourgois et al.) discloses a protective textile fabric comprising a plurality of steel cords twisted together. WO 200186046 (Vanassche et al.) discloses a fabric comprising steel elements used to provide cut resistance or reinforcement for protective textiles. The steel elements are either a single steel wire, a bundle of non-twisted steel wires, or a cord of twisted steel fibers. GB 2324100 (Soar) discloses a protective material made from twisted multi-strand cable which may be stitched to one or more layers of Kevlar® to form a unitary material. The use of bare metal wire presents processing challenges and garment aesthetic (comfort and feel) problems and is undesirable.

U.S. Pat. No. 4,470,251 (Bettcher) discloses a cut resistant yarn made by winding a number of synthetic fibers yarns, such as nylon and aramid, around a core of strands of stainless steel wire and a high strength synthetic fiber such as aramid, and a safety garment made from the wound yarn.

U.S. Pat. No. 5,119,512 (Dunbar et al.) discloses a protective fabric made from cut resistant yarn comprising two dissimilar non-metallic fibers, at least one being flexible and inherently cut resistant and the other having a level of hardness at above three Mohs on the hardness scale.

### SUMMARY OF THE INVENTION

The present invention is directed to a woven fabric useful in protective apparel made from yarn components comprising a body fabric yarn component and a cut resistant ripstop yarn component, the cut resistant ripstop yarn component comprising a cut resistant yarn having a synthetic staple-fiber sheath and inorganic core, the ripstop yarn component having at least 50% greater tensile strength than the body fabric yarn component, the body fabric yarn component and the ripstop yarn component each being comprised of at least one yarn and each yarn component distinguished from the adjacent yarn component by interweaving orthogonal yarn components. The staple-fiber sheath of the cut resistant yarn of the ripstop yarn component preferably comprises staple fibers that are made from poly (p-phenylene terephthalamide) and the inorganic core comprises preferably metal fiber. The cut resistant ripstop yarn component can also contain a textured or bulked continuous filament yarn. The cut resistant ripstop yarn component preferably contains fibers that are both cut resistant and fire resistant, and the preferred fiber having both of these qualities is poly (p-phenylene terephthalamide) fiber. In addition, the cut resistant ripstop yarn component may contain nylon fibers in an amount of up to 20% by weight of the ripstop yarn component. The body fabric component of this invention comprises yarns of fire-resistant fibers, and preferably comprises, in addition to fire-resistant fibers, nylon fibers in an amount of up to 20% by weight of the body fabric yarn component.

One embodiment of this invention is directed to a woven fabric useful in protective apparel made from yarn components comprising a body fabric yarn component and a cut resistant ripstop yarn component comprising a cut resistant yarn having a synthetic staple-fiber sheath and inorganic core, the cut resistant ripstop yarn component having at least 50% greater tensile strength than the body fabric yarn component; the body fabric yarn component and the cut resistant ripstop yarn component being comprised of individual or plied warp and fill yarns in the fabric, and wherein every fifth to ninth orthogonal warp and fill yarn component is a cut resistant ripstop yarn component. Further, the cut resistant ripstop yarn component can contain a textured or bulked continuous filament yarn.

This invention is also directed to a process for making a woven fabric useful in protective apparel made from warp and fill yarn components comprising weaving a fabric from a body fabric yarn component, and inserting into the weave at every fifth to ninth warp and/or fill component a cut resistant ripstop yarn component comprising a cut resistant yarn having a synthetic staple-fiber sheath and inorganic core, said ripstop yarn component having at least 50% greater tensile strength than the body fabric yarn component.

### BRIEF DESCRIPTION OF THE DRAWINGS

FIG. 1 is an illustration of some of the possible yarn components in the fill direction separated by interweaving orthogonal warp yarn components in the fabric of this invention.

FIG. 2 is illustration of a cut resistant yarn having a staple fiber sheath/and inorganic core construction.

FIG. 3 is an illustration of one embodiment of the fabric of this invention.

FIG. 4 is an illustration of another embodiment of the fabric of this invention.

### DETAILED DESCRIPTION OF THE INVENTION

The fabrics of this invention have in combination improved cut resistance and improved tear resistance over prior art fabrics and preferably have improved abrasion resistance. The fabrics are woven using known machines for weaving fabric and can be incorporated into protective apparel and garments of various types. These fabrics typically weigh in the range of 4 to 12 ounces per square yard and can be any orthogonal weave, however plain weave and 2×1 twill weave are the preferred weaves.

This invention comprises two types of yarn components, a body fabric yarn component and a cut resistant ripstop yarn component having incorporated therein a cut resistant yarn. As referred to herein, a yarn component can be a yarn, a plied yarn, or a combination of yarns or a combination of plied yarns. In general, each yarn component lying in one direction of a woven fabric is distinguished from the adjacent yarn component in that same direction by interweaving orthogonal yarn components. In a plain weave, for example, the warp and fill yarn components are interwoven wherein the warp yarn components go over and under the fill yarn components, delineating each fill yarn component and distinguishing it from the adjacent fill yarn component. Likewise, adjacent warp yarn components alternate the direction of the interweave with the fill yarn; that is, a first warp yarn component will go over a fill yarn component and a second adjacent warp yarn component will go under that same fill yarn component. This alternate interweaving action is duplicated throughout the fabric creating the classic plain weave structure. Therefore, the fill yarn components also delineate each warp yarn component from adjacent warp yarn components. In a twill weave, the warp and fill yarn components are interpreted the same even though there is less actual interweaving of warp and fill yarn components. In a 2×1 twill weave, the offset staggered interweaving structure of that weave means a warp yarn component passes over more than one fill yarn component and lies directly adjacent to another warp yarn component periodically in the fabric. However, the warp and fill yarn components are still delineated by each other even if they are offset or staggered in the fabric, and the yarn components can be clearly identified by inspection.

Typically, the major portion of the fabric is made from body fabric yarn components and these components normally comprise yarns containing fire-resistant fibers. The term “fire resistance fibers” as used herein means staple or filament fibers of polymers containing both carbon and hydrogen and which may also contain other elements such as oxygen and nitrogen, and which have a LOI 25 and above. Suitable fire-resistant fibers include poly (meta-phenylene isophthalamide) (MPD-I), poly (para-phenylene terephthalamide) (PPD-T), polybenzimidazoles (PBI), poly-phenylene benzobisoxazole (PBO), and/or blends or mixtures of those fibers. For improved abrasion resistance, the body fabric yarn components can have in addition to the fire-resistant fibers up to 20 percent by weight nylon fibers, preferably less than 10 percent by weight. The body fabric yarn components are preferably staple yarns containing 60 weight percent PPD-T fiber and 40 weight percent PBI fiber. The preferred form and size of the body fabric yarn component is a plied yarn of the above composition having a cotton count in the range of 16/2 to 21/2.

The cut-resistant ripstop yarn component of the fabric is useful in providing both cut resistance and tear strength to the fabric and has a tensile strength which is at least 50% greater than the tensile strength of a body fabric yarn component. The cut resistant ripstop yarn component contains at least one cut resistant yarn having a synthetic staple fiber sheath and an inorganic core and can also contain, in addition, continuous synthetic multifilament yarn. It is preferred that the cut resistant ripstop yarn component contain fibers which are fire-resistant. Suitable fire-resistant fibers include those made from aramids such as poly (para-phenylene terephthalamide) (PPD-T), poly(meta-phenylene isophthalamide) (MPD-I), and other high strength polymers such as poly-phenylene benzobisoxazole (PBO) and/or blends or mixtures of those fibers. The cut resistant ripstop yarn component preferably contains 1 to 3 continuous filament yarns. If one yarn is used for the cut resistant ripstop yarn component, that one yarn must have at least 50% greater tensile strength than the tensile strength of a body fabric yarn component; if three yarns are used for the cut resistant ripstop yarn component, then the combined three yarns must have a tensile strength of at least 50% or greater than that of the body fabric component. If more than one yarn is used as the cut resistant ripstop yarn component, the yarns may be plied together or may be used without plying. The total denier of the cut resistant ripstop yarn component is in the range of 200 denier to 1500 denier and the denier of continuous filament yarns suitable for use in the cut resistant ripstop yarn component is in the range of 200-1000 denier. The cut resistant ripstop yarn component can also have, combined with or in addition to the fire-resistant yarn, up to 20 percent nylon fiber for improve abrasion resistance.

The cut resistant ripstop yarn component of the fabric of this invention contains at least one yarn having a sheath/core construction wherein the sheath comprises synthetic fibers and the core comprises inorganic fibers. The fibers in the sheath are comprised of synthetic staple fibers for they create a more comfortable yarn. Preferably, the synthetic fibers in the sheath comprises cut resistant fibers, which can include any number of fibers made from poly (para-phenylene terephthalamide) (PPD-T) and other high strength polymers such as poly-phenylene benzobisoxazole (PBO) and mixtures or blends thereof. It is preferred that that the cut resistant fibers also be fire resistant and the preferred fire retardant and cut resistant fiber is PPD-T fiber. The sheath can also include some fibers of other materials to the extent that decreased cut resistance, due to that other material, can be tolerated. The cut resistant yarn component can also have, combined with or in addition to the cut resistant fibers, up to 20 percent by weight nylon fiber for improved abrasion resistance.

The core of the sheath/core yarn contains at least one inorganic fiber. Inorganic fibers useful in the core include glass fiber or fibers made from metal or metal alloys. The metal fiber core can be a single metal fiber or several metal fibers, as needed or desired for a particular situation. The preferred core fiber is a single metal fiber made from stainless steel. By metal fibers is meant fibers or wire made from a ductile metal such as stainless steel, copper, aluminum, bronze, and the like. The metal fibers are generally continuous wires and are 10 to 150 micrometers in diameter, and are preferably 25 to 75 micrometers in diameter.

The staple fibers comprising the sheath can be wrapped or spun around metal fiber core. If wrapped, the staple fibers are generally in the form of staple fibers loosely consolidated or spun by known means, such as, ring spinning, wrap spinning, air-jet spinning, open-end spinning, and the like; and then wound around the metal core at a density sufficient to substantially cover the core. If spun, the staple fiber sheath is formed directly over metal fiber core by any appropriate sheath/core-spinning process such as DREF spinning or so-called Murata jet spinning or another core spinning process. The fire retardant PPD-T staple fibers present in the sheath have a diameter of 5 to 25 micrometers and may have a length of 2 to 20 centimeters, preferably 4 to 6 centimeters. Once the staple fibers are wrapped or spun around the core, these sheath/core yarns having the preferred metal fiber core are generally 1 to 50 weight percent metal with a total linear density of 100 to 5000 dtex.

FIG. 2 is an illustration of a cut resistant yarn 7 that may be used in the cut resistant ripstop yarn component of this invention. The yarn has a staple fiber sheath 9 that is disposed around an inorganic core fiber 8. The cut resistant ripstop yarn component of this fabric can be made from a combination of plied yarns, although only one of the yarns in this combination of plied yarns is required to have the sheath/core construction. For example, if the cut resistant yarn component is to have three yarns, these three yarns can be twisted or plied about each other to form a plied yarn. However, only one of the three yarns is required to have the sheath/core construction. Likewise, for example, if the cut resistant yarn component is to have four yarns, these four yarns can be paired and then twisted or plied about each other to form two plied yarns. However, only one of the four yarns is required to have the sheath/core construction. Plied yarns are yarns that are brought together with only a small amount of twist, normally in the range of 5 to 10 turns or twists per inch. This low amount of twisting provides for a consolidated and balanced yarn without totally covering or wrapping one yarn with the other yarn.

The remaining yarns in the cut resistant ripstop yarn component can have almost any construction, but it is desired that they be comprised of predominantly fire resistant materials so as to maintain the fire resistant nature of the garment. Specifically, these remaining yarns can be made from aramid staple fibers or continuous aramid filaments, and may contain other fibers and materials. However, it must be recognized the fire retardancy and/or cut resistance of the fabric may be diminished by the presence of such other materials. Typically, these remaining yarns can have a linear density in the range of 200 to 2000 dtex and the individual filaments or fibers have a linear density of 0.5 to 7 dtex, preferably 1.5 to 3 dtex.

The preferred construction of the cut resistant yarn used in the cut resistant ripstop yarn component is a plied yarn made from two sheath/core yarns wherein for each yarn the sheath is staple fiber PPD-T having a cut length of 48 mm (1.89) and the core is a 1.5 mil diameter stainless steel filament. The preferred yarn has a cotton count sizing of 16/2 to 21/2 (664 - 465 denier). Optionally, the sheath/core yarns may have in addition to the fire retardant cut resistant fiber in the sheath up to 10 weight percent and as much as 20 weight percent nylon, based on the weight of the sheath fiber, to provide improved abrasion resistance.

If the cut resistant ripstop yarn component contains a continuous synthetic multifilament yarn, that yarn preferably is a textured or bulked continuous filament yarn, and the preferred fiber for that yarn is 600 denier PPD-T fiber having a linear density of 1.5 dpf. The continuous multifilament yarn used in the cut resistant ripstop yarn component is textured or bulked to co-mingle the filaments and create a random entangled loop structure in the yarn. One process known in the art which accomplishes this is called air-jet texturing wherein pressurized air, or some other fluid, is used to rearrange the filament bundle and create loops and bows along the length of the yarn. In a typical process, the multi-filament yarn to be bulked is fed to a texturing nozzle at a greater rate than it is removed from the nozzle. The pressurized air impacts the filament bundle, creating loops and entangling the filaments in a random manner. For the purposes of this invention, it is desirable to have an overfeed rate of 14 to 25% with a usable range in the order of 5 to 30%. Using a bulking process with this overfeed rate creates a co-mingled yarn having a higher weight per unit length, or denier, than the yarn that was fed to the texturing nozzle. It has been found that the increase in weight per unit length should be in the range of 3 to 25 weight percent, with increases in the 10 to 18 weight percent preferred. It has been found that the bulked yarn that is most useful in the making of the fabric in this invention is preferably in the range of 200 to 1000 denier, and more preferably 300 to 600 denier. The loops and entanglements create a continuous filament yarn which has some surface characteristics similar to a spun staple yarn.

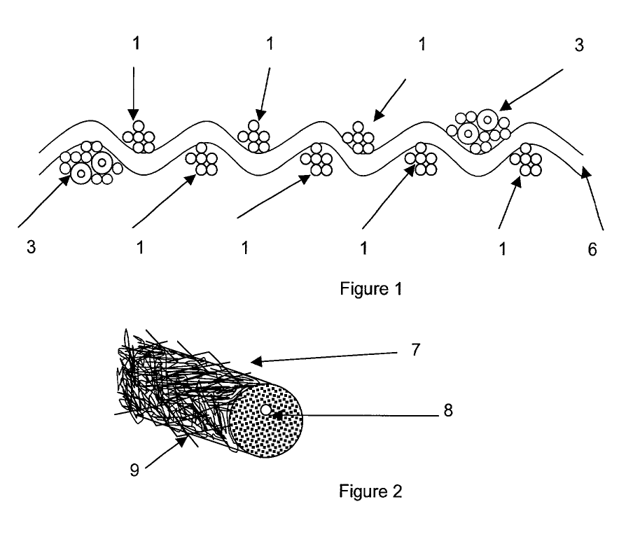

FIG. 1 is a very simplified illustration of some of the possible fill yarn components separated by interweaving orthogonal warp yarn components. Body yarn components 1 made from, for example, a collection of staple yarns, are shown separated from such things as other body yarn components and cut resistant ripstop yarn components 3 by the interweaving warp yarn component 6. A possible cut resistant yarn ripstop component 3 is shown having the preferred combination of types of yarns, namely textured continuous filament yarns and a plied yarn made from two staple sheath/inorganic core cut resistant yarns, with the inorganic core shown in those yarns not to scale but magnified for illustration purposes. The body fabric yarn component 1 can be made up from a combination of single yarns and/or plied yarns. Similar types of yarn components can be, and preferably are, present in the warp direction.

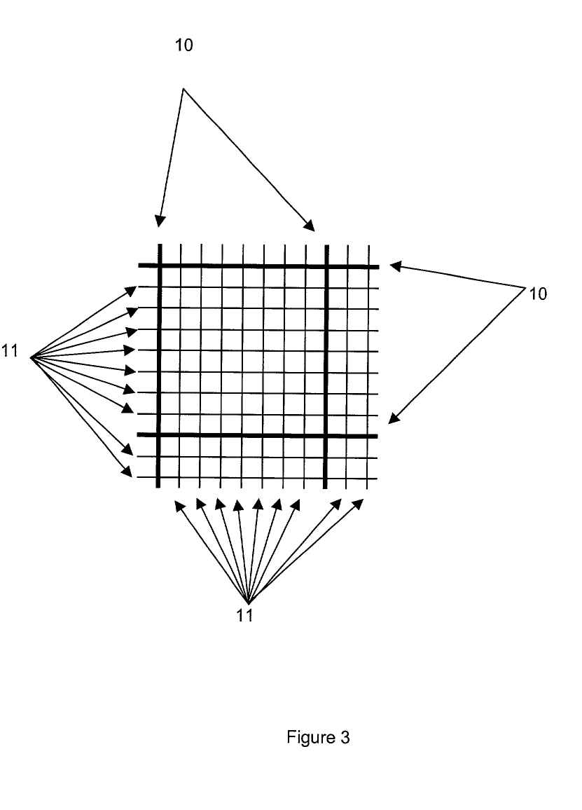

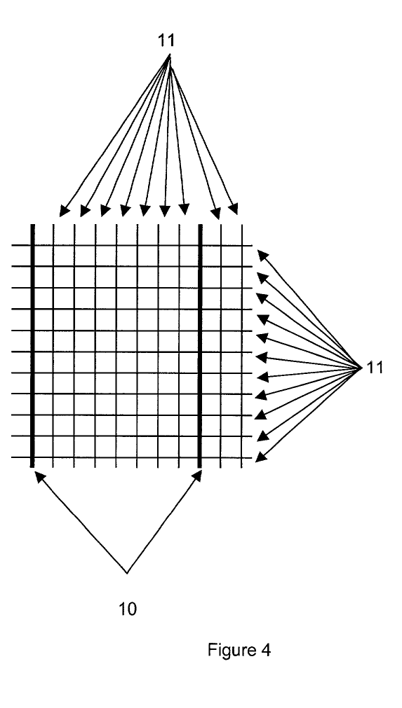

The woven fabric of this invention typically has a predominance of body fabric yarn components with only enough of the cut resistant ripstop yarn components to allow the fabric to perform in the fabric's intended use. It is desirable to have cut resistant ripstop yarn components in both the warp and fill directions. Further, it is desired to uniformly distribute the cut resistant ripstop yarn components throughout the fabric in both the warp and fill directions so that the durability imparted by the cut resistant ripstop yarn component is uniform across the fabric. Further, it is believed that the most useful fabrics are made when the cut resistant ripstop yarn component is distributed in the fabric as every fifth to ninth orthogonal warp and fill yarn component in the fabric, with the preferred spacing having a cut resistant ripstop yarn component every seventh warp and fill yarn component. If a high proportion of the body fabric yarn components are made from staple yarns, it will be desirable to bulk or texture any continuous filaments used in the ripstop yarn component. FIG. 3 is an illustration of one embodiment of the fabric of this invention with the warp and fill yarn components shown broadly separated and simplified for illustration purposes. Cut resistant ripstop yarn components 10 are shown in both the warp and fill and are present as every eighth component in the fabric. Body fabric yarn components 11 are shown in both the warp and fill between the cut resistant ripstop yarn components.

In another embodiment of this invention, the woven fabric of this invention is made from body fabric yarn components and cut resistant ripstop yarn components wherein each cut resistant ripstop yarn component has at least 50% greater tensile strength than each body fabric yarn component, the cut resistant ripstop yarn component comprises a yarn having a synthetic staple-fiber sheath and an inorganic core, and the cut resistant ripstop yarn components are present in only the warp or the fill of the fabric. The cut resistant ripstop yarn component can also contain continuous multifilament yarn which may be textured or bulked. FIG. 4 is an illustration of this type of fabric. The cut resistant ripstop yarn components 10 are shown only in the warp direction and all other warp yarns are body fabric yarn components 11. The yarn components shown in the fill direction are all body fabric yarn components 11.

This invention is also directed to a process for making the fabric of this invention comprising weaving a fabric from a body fabric yarn component and inserting into the weave at every fifth to ninth warp and fill component a cut resistant ripstop yarn component comprising a yarn having synthetic staple fiber sheath and an inorganic core said cut resistant yarn component having at least 50% greater strength than the body fabric yarn component.

Another embodiment of the process for making the woven fabric of this invention having orthogonal yarn components involves weaving a fabric from a body fabric yarn component, inserting into the weave at every fifth to ninth yarn component a cut resistant ripstop yarn component, creating a parallel array of those components in the fabric, each component comprising a yarn having synthetic staple fiber sheath and an inorganic core and each component having at least 50% greater tensile strength than the body fabric yarn component.

The fabrics of this invention are useful in and can be incorporated into protective garments, especially garments known as turnout gear which are useful for firefighters. These garments also have use in industrial applications where workers may be exposed to abrasive and mechanically harsh environments where fire and flame protection is needed. The garments, may include coats, coveralls, jackets, pants, sleeves, aprons, and other types of apparel where protection against fire, flame, and heat is needed.

### TEST METHODS

### Thermal Protective Performance Test (TPP)

The predicted protective performance of a fabric in heat and flame was measured using the “Thermal Protective Performance Test” NFPA 2112. A flame was directed at a section of fabric mounted in a horizontal position at a specified heat flux (typically 84 kW/m²). The test measures the transmitted heat energy from the source through the specimen using a copper slug calorimeter and there is no space between fabric and heat source. The test endpoint is characterized by the time required to attain a predicted second-degree skin burn injury using a simplified model developed by Stoll & Chianta, “Transactions New York Academy Science”, 1971,33 p649-670. The value assigned to a specimen in this test, denoted as the TPP value, is the total heat energy required to attain the endpoint, or the direct heat source exposure time to the predicted burn injury multiplied by the incident heat flux. Higher TPP values denote better insulation performance. A three layer testing sample is prepared consisting of outer shell fabric (current invention), a moisture barrier and a thermal liner. The moisture barrier was Crosstech® attached to a 2.7 oz/yd² (92 grams/square meter) Nomex®/Kevlar® fiber substrate and the thermal liner consisted of three spunlaced 1.5 oz/yd² (51 grams/square meter) sheets quilted to a 3.2 oz/yd² (108 grams/square meter) Nomex® staple fiber scrim.

### Abrasion Resistance Test

Abrasion resistance was determined using ASTM method D3884-80, with a H-18 wheel, 500 gms load on a Taber abrasion resistance available from Teledyne Taber, 455 Bryant St., North Tonawanda, N.Y. 14120. Taber abrasion resistance is reported as cycles to failure.

### Cut Resistance Test

Cut resistance was measured using the “Standard Test Method for Measuring Cut Resistance of Materials Used in Protective Clothing”, ASTM Standard F 1790-97. In performance of the test, a cutting edge, under specified force, was drawn one time across a sample mounted on a mandrel. At several different forces, the distance drawn from initial contact to cut through was recorded and a graph constructed of force as a function of distance to cut through. From the graph, the force was determined for cut through at a distance of 25 millimeters and was normalized to validate the consistency of the blade supply. The normalized force was reported as the cut resistance force. The cutting edge was a stainless steel knife blade having a sharp edge 70 millimeters long. The blade supply was calibrated by using a load of 400 g on a neoprene calibration material at the beginning and end of the test. A new cutting edge was used for each cut test. The sample was a rectangular piece of fabric cut 50×100 millimeters on the bias at 45 degrees from the warp and fill directions. The mandrel was a rounded electrical conductive bar with a radius of 38 millimeters and the sample was mounted thereto using double-face tape. The cutting edge was drawn across the fabric on the mandrel at a right angle with the longitudinal axis of the mandrel. Cut through was recorded when the cutting edge makes electrical contact with the mandrel.

### Tear Strength Test

The tear strength measurement is based on ASTM D 5587-96. This test method covers the measurement of the tear strength of textile fabrics by the trapezoid procedure using a recording constant-rate-of-extension-type (CRE) tensile testing machine. Tear strength, as measured in this test method, requires that the tear be initiated before testing. The specimen was slit at the center of the smallest base of the trapezoid to start the tear. The nonparallel sides of the marked trapezoid were clamped in parallel jaws of a tensile testing machine. The separation of the jaws was increased continuously to apply a force to propagate the tear across the specimen. At the same time, the force developed was recorded. The force to continue the tear was calculated from autographic chart recorders or microprocessor data collection systems. Two calculations for trapezoid tearing strength were provided: the single-peak force and the average of five highest peak forces. For the examples of this patent, the single-peak force is used.

### Grab Strength Test

The grab strength measurement, which is a determination of breaking strength and elongation of fabric or other sheet materials, is based on ASTM D5034. A 100-mm (4.0 in.) wide specimen is mounted centrally in clamps of a tensile testing machine and a force applied until the specimen breaks. Values for the breaking force and the elongation of the test specimen are obtained from machine scales or a computer interfaced with testing machine.

### EXAMPLES

### EXAMPLE 1

This example illustrates the fabric of this invention utilizing a cut resistant ripstop yarn component containing a cut resistant yarn having a stainless steel wire core and a PPD-T /nylon staple fiber sheath. The staple fiber sheath was a blend of 90 weight percent PPD-T staple fiber (Kevlar® fiber 1.5 dpf, 48 mm (1.89 inch) available from E. I. du Pont de Nemours & Co., Inc.) and 10 weight percent nylon staple fiber (Nylon type T200, 1.1 dpf and 38mm (1.5 inch) available from E. I. du Pont de Nemours & Co., Inc. The steel wire was 1.5 mil in diameter.

The PPD-T and nylon fibers were fed through a standard carding machine used in the processing of short staple ring spun yarns to make carded sliver. The carded sliver was processed using two pass drawing (breaker/finisher drawing) into drawn sliver and processed on a roving frame to make a one hank roving. The roving was then fed into spinning frame with steel wire to form a sheath/core yarn structure. Sheath-core strands were produced by ring-spinning two ends of the roving and inserting the steel core just prior to twisting. The roving was about 5900 dtex (1 hank count). In this example, the steel core was centered between the two drawn roving ends just prior to the final draft rollers. 16/1 cc strands were produced using a 3.5 twist multiplier for each item. The single strand of 16/1 cc is then plied to 16/2 cc to form a stable yarn for further weaving process.

A commercially available ring-spun yarn containing PPD-T and PBI fiber (1.5 dpf, 51 mm (2 inch)) having those fibers present in a 60/40 blending ratio was obtained from Pharr Yarns, Inc., of 100 Main Street, McAdenville, N.C., for use in the body fabric yarn component.

A 5/2 cut resistant ripstop plain weave fabric was made, wherein the cut resistant ripstop yarn component (CRRYC) was 2 yarns of the sheath/core PPD-T/nylon and steel yarn mentioned above plied together. Each body fabric yarn component (BFYC) contained one of the PPD-T/PBI plied yarns. In the warp and fill, for the 5/2 construction was CRRYC /BFYC/BFYC/BFYC/BFYC/BFYC/CRRYC. The fabric is then heated in oven at 265C. for 5 mins. The heat treatment caused the nylon to shrink to further improve the abrasion resistance of the fabric.

### EXAMPLE 2

In this example, a highly wear resistant and cut resistant plain weave fabric for thermal protection was prepared. PPD-T, PBI and nylon staple fiber identical to those used in Example 1 were blended in percentages of 50%, 40% and 10%, respectively, and were fed through a standard carding machine used in the processing of short staple ring spun yarns to make carded sliver. The carded sliver was processed using two pass drawing (breaker/finisher drawing) into drawn sliver and processed on a roving frame to make a one hank roving. The roving was then fed into spinning frame. The roving was about 5900 dtex (1 hank count). 16/1 cc strands were produced using a 3.5 twist multiplier for each item. The single strand of 16/1 cc is then plied to 16/2 cc to form a stable yarn for further weaving process. These plied yarns became the body fabric yarn components in the fabric. Each body fabric yarn component contained one of the plied yarns.

The cut resistant ripstop component was made from one cut resistant yarn of PPD-T/nylon staple fiber sheath and a stainless steel wire core, same as example 1, along with one yarn of 600 denier textured PPD-T continuous filament yarn.

The 7×2 ripstop plain weave fabric was made from these two components, where the body of plain weave area was made from the body fabric yarn components, while every 8^{th} warp and fill component a cut resistant ripstop yarn component was inserted. The resulted fabric had high strength, cut and abrasion resistance.

TABLE 1
The testing results of the various fabric samples

| | | | Example 2 |
|---|---|---|---|
| | | | 7 body yarn |
| | | | components of |
| | | | Kevlar/PBI/nylon |
| | | Example 1 | blend in |
| | | 5 body yarn | plain weave |
| | | components of | and 1 end of |
| | | Kevlar/PBI blend | stainless Steel |
| | Standard | in plain weave | wrapped with |
| | Kevlar ®/PBI | and 2 ends of | Kevlar-nylon |
| | Kevlar ®/PBI | stainless Steel | and 1 end of |
| | blend with | wrapped with | 600 textured |
| | double ends | Kevlar-nylon in | Kevlar ® |
| | in ripstop | ripstop | in ripstop |
| Test Type | component | component | component |
| Basis Wt. | 257.6 | 264.4 | 267.8 |
| (g/m2) | | | |
| Thickness | 0.66 | 0.89 | 1.22 |
| (mm) | | | |
| Trap Tear | 13.1 × 12.3 | 16.3 × 15.9 | 32.2 × 31.3 |
| (warp × fill kg) | | | |
| Grab Strength | 119.4 × 105.3 | 114 × 117.1 | 116.2 × 96.7 |
| (warp × fill kg) | | | |
| Abrasion | 184 | 193 | 280.6 |
| (cycles) | | | |
| Cut Resistance | 469 | 1251 | 788 |
| (g) | | | |
| TPP (cal/cm\hat{ }2) | 42 | 48 | 41.2 |

What is claimed is:

1. A woven fabric useful in protective apparel made from yarn components comprising:
a body fabric yarn component,
a ripstop yarn component comprising a cut resistant yarn having a synthetic staple-fiber sheath and inorganic core, said ripstop yarn component having at least 50% greater tensile strength than the body fabric yarn component,
the body fabric yarn component and the ripstop yarn component being comprised of at least one yarn and each yarn component distinguished from the adjacent yarn component by interweaving orthogonal yarn components.

2. The woven fabric of claim 1 wherein the ripstop yarn component comprises a textured or bulked continuous filament yarn.

3. The woven fabric of claim 1 wherein the ripstop yarn component comprises poly (p-phenylene terephthalamide) fibers.

4. The woven fabric of claim 1 wherein the ripstop yarn component comprises fire-resistant fibers.

5. The woven fabric of claim 4 wherein the ripstop yarn component comprises, in addition to fire-resistant fibers, nylon fibers in an amount of up to 20% by weight of the ripstop yarn component

6. The woven fabric of claim 1 wherein the staple-fiber sheath comprises staple fibers are made from poly (p-phenylene terephthalamide) and the inorganic core comprises metal fiber.

7. The woven fabric of claim 1 wherein the ripstop yarn component comprises cut resistant fibers.

8. The woven fabric of claim 7 wherein the ripstop yarn component comprises, in addition to the cut resistant fibers, nylon fibers in an amount of up to 20% by weight of the ripstop yarn component yarn.

9. The fabric of claim 1 wherein the body fabric component comprises yarns of fire-resistant fibers.

10. The woven fabric of claim 9 wherein the body fabric yarn component yarn comprises, in addition to fire-resistant fibers, nylon fibers in an amount of up to 20% by weight of the body fabric yarn.

11. A woven fabric useful in protective apparel made from yarn components comprising:
a) a body fabric yarn component,
b) a ripstop yarn component comprising a cut resistant yarn having a synthetic staple-fiber sheath and inorganic core, said ripstop yarn component having at least 50% greater tensile strength than the body fabric yarn component, the body fabric yarn component and the ripstop yarn component being comprised of individual or plied warp and fill yarns in the fabric, and
wherein every fifth to ninth orthogonal warp and fill yarn component is a ripstop yarn component.

12. The woven fabric of claim 11 wherein the ripstop yarn component comprises a textured or bulked continuous filament yarn.

13. A process for making a woven fabric useful in protective apparel made from warp and fill yarn components comprising:
a) weaving a fabric from a body fabric yarn component, and
b) inserting into the weave at every fifth to ninth warp and fill component a ripstop yarn component comprising a cut resistant yarn having a synthetic staple-fiber sheath and inorganic core, said ripstop yarn component having at least 50% greater tensile strength than the body fabric yarn component.

14. The process of claim 13 wherein the ripstop yarn component is assembled, prior to insertion into the weave, by including, in addition to the cut resistant yarn, a textured or bulked continuous filament yarn.

15. A process for making a woven fabric useful in protective apparel made from warp and fill yarn components comprising:
a) weaving a fabric from a body fabric yarn component, and
b) inserting into the weave at every fifth to ninth warp and fill component a ripstop yarn component to create an array of cut resistant ripstop yarn components, each component comprising a cut resistant yarn having a synthetic staple-fiber sheath and inorganic core, said ripstop yarn component having at least 50% greater tensile strength than the body fabric yarn component.

16. The process of claim 15 wherein the ripstop yarn component is assembled, prior to insertion into the weave, by including, in addition to the cut resistant yarn, a textured or bulked continuous filament yarn.
